(19) United States
(12) Patent Application Publication
(10) Pub. No.: US 2008/0155586 A1
(43) Pub. Date: Jun. 26, 2008

(54) Method and device for processing video stream in digital video broadcasting systems

(75) Inventors: Yu Dong Yang, Beijing (CN); Yu Yuan, Beijing (CN); Guo Hui Lin, Beijing (CN); You Zhou, Beijing (CN)

Correspondence Address: SCULLY, SCOTT, MURPHY & PRESSER, P.C., 400 GARDEN CITY PLAZA, SUITE 300, GARDEN CITY, NY, 11530, US

(73) Assignee: International Business Machines Corporation, Armonk, NY (US)

(21) Appl. No.: 12/001,713

(22) Filed: Dec. 11, 2007

(30) Foreign Application Priority Data
Dec. 11, 2006 (CN) 200610165661.5

(51) Int. Cl. H04N 7/025

(52) U.S. Cl. 725/32

(57) ABSTRACT

The invention provides a novel method for enhancing user experiences, especially when changing channels, in digital video broadcasting systems. The invention provides a mechanism to show a low resolution version of the contents immediately after the channel change, and then automatically switch to the high resolution content once the new GOP is started, thus the user will not see blank screen during the waiting period.

### FIELD OF THE INVENTION

The invention relates to a method and system for processing video stream in digital video broadcasting system, especially to a method and system for enhancing user experience during channel change.

### BACKGROUND OF THE INVENTION

Digital video broadcasting systems heavily rely on advanced digital video coding algorithms to provide vivid contents over the limited bandwidth of transportation channels. Most of today's video coding algorithms take advantage of predictive coding to eliminate the data redundancy between succeeding video frames. Normally, the predictive coding starts with one video frame coded without referring to any other video frames (the frame is called Intra frames or I-frames) and then the succeeding video frames are predicted based on the I-frame as well as other video frames coded before them (these frames are called reference frames). The group of video frames mentioned above is usually referred as one GOP (Group Of Pictures), as shown in FIG. 1. It is the case that one GOP can only be decoded from the first I-frame. Theoretically, a 90-minute movie can be compressed in one GOP structure, but will result in inconvenience in that a user could not start watching it from somewhere in the middle. It would be much more convenient if the GOP structure is rather shorter, but the efficiency of video coding will be reduced due to too many I-frames, because the efficiency of coding I-frames is rather low compared to the predictive coded frames. The common trade off is using GOP structures with lengths from several to tens of seconds. It should be noted that in video coding standards such as MPEG-2, limited length of GOP is also suggested because the accumulation of predictive coding errors may cause visual artifact.

There are usually multiple video program streams being broadcasted simultaneously in a digital video broadcasting system. End users watch the video content by selecting which stream is to be decoded. By switching to another video stream and then restarting decoding process, the channel change is done. As shown in FIG. 2, when user changes the channel from stream X to Y, if the switch point is just within a short period after the start of a new GOPm+1 in stream Y, the decoding of stream Y will not be able to start until the new GOPm+2 arrives. It is simply because that the complete data of GOPm+1, especially the I-frame data can not start decoding correctly when the switch happens. The user may wait for several seconds or even tens of seconds before the new channel shows depends on the length of GOP. During this waiting period, the screen either displays a freeze frame from last channel or is completely blank.

The method flow of a common channel change in digital video broadcasting system according to the prior art, will be described with reference to FIG. 3.

After receiving a selection of new channel from user at step S310, the channel change flow enters step S320 in which the decoding of a current content stream X in the decoder is stopped and the cache in the decoder is cleared. At this time, normally a blank screen or a frozen frame of X is shown.

The flow will then enter step S330 in which the content stream to be replayed is tuned to a new content stream Y by changing system parameters as is known in the art and thus will not be described in detail.

Then, the flow enters step S340 in which the image data of content stream Y is acquired. At step S350, whether new GOP has arrived is determined. If yes, at step S360, the decoding of the image data of content stream Y is started in the decoder and the decoded new content stream Y is displayed on the screen, as shown in FIG. 6A. If the result of the determination at step S350 shows that there's no new GOP arrived, the image data will be discarded at step S370 and the flow will return to step S340 to continue to acquire image data.

It can be seen from the flow described above that, in order to avoid displaying artifacts, the decoder must wait until the new GOP of content stream Y has arrived to start real decoding. As the GOP structure is long, the waiting period will probably lead to or cause a blank screen or a still image of last channel for a rather long period.

The user experience is thus negatively affected due to the long duration of waiting between the channel changes compared to the analog TV. The situation is even worse with the introduction of new video coding standards as MPEG-4 and H.264, in which the preferred GOP length is in range of tens of seconds in order to reach extremely high coding efficiency.

There are some known solutions to this problem:

One direct solution is to use short GOP structures in the high resolution content streams. The major drawback of this solution is low coding efficiency that results in either low video quality with limited bandwidth or high bandwidth utilization with designated video quality.

Another possible solution is to use layered video coding technique with low resolution coding layers using short GOP structures while high resolution coding layers (also known as enhanced layer) using long GOP structures. The decoding of high resolution coding layers has to be carried out after the decoding of low resolution coding layers, because high resolution coding layers need prediction not only from the same layer but from low resolution coding layer. No layered video coding technique is used in the current digital video broadcasting schemas due to its complexity and high cost.

There is also proposed that the program stream be decoded using the incomplete GOP data so that there will be something updated on the viewer display screen. However, the resulting display can be very unpleasant due to the incomplete data. That is, as shown in FIG. 6B, heavy block artifacts will be shown. In most user experiences, these kinds of artifacts are barely acceptable.

### SUMMARY OF THE INVENTION

Accordingly, the present invention is directed to a novel method for enhancing user experiences, especially when changing channels, in digital video broadcasting systems. The invention provides a mechanism to show a low resolution version of the contents immediately after the channel change, and then automatically switch to the high resolution content once the new GOP is started, thus the user will not see blank screen during the waiting period.

According to one aspect of the invention, there is provided a system, method and computer program product for processing a content stream in digital video broadcasting system.

In one aspect, the method for processing a content stream in digital video broadcasting stream comprises:

receiving, in response to a user selection of a broadcast channel, a content stream comprising a high resolution content stream and a low resolution content stream corresponding to the selected channel, wherein the respective high resolution content stream and low resolution content stream is comprised of at least one Group Of Pictures (GOP) structure;

detecting the start of the high resolution content stream; and, in response to detection,

decoding and displaying the high resolution content stream in response to the detection of the start of the high resolution content stream; otherwise, decoding and displaying the low resolution content stream.

In one embodiment, the size of the GOP structure of the low resolution content stream is smaller than that of the high resolution content stream.

Furthermore, the high resolution content stream and the low resolution content stream are synchronous in the time domain.

According to another aspect of the invention, there is provided a method for processing content stream in digital video broadcasting system comprising:

encoding the content stream to form high resolution content stream, the high resolution content stream comprising at least one Group Of Pictures (GOP) structure;

encoding the content stream to form low resolution content stream, the low resolution content stream comprising multiple GOP structures, wherein the size of the GOP of the low resolution content stream is smaller than that of the high resolution content stream; and,

multiplexing the high resolution content stream and the low resolution content stream for transmission over a communication channel as a digital video stream associated with a channel.

In one embodiment, the multiplexing of said high resolution content stream and said low resolution content stream is by time division multiplexing.

Further to this aspect, the digital video stream is received at a user display device and immediately upon detection of a receipt of a high resolution content stream, decoding and displaying said high resolution content stream.

The method further includes mechanism to show a low resolution version of the contents immediately after the channel change; and then

automatically switching to the high resolution content once the new GOP is started,

According to yet another aspect of the invention, there is provided an apparatus for processing content stream in digital video broadcasting system comprising:

means for receiving, in response to a user selection of a broadcast channel, a content stream comprising high resolution content stream and low resolution content stream corresponding to the selected channel, wherein the high resolution content stream and low resolution content stream is respectively comprised of at least one Group Of Pictures (GOP) structure;

means for detecting the start of the high resolution content stream; and

means for decoding and displaying the high resolution content stream in response to the detection of the start of the high resolution content stream; otherwise, decoding and displaying the low resolution content stream.

In one embodiment, the size of the GOP structure of the low resolution content stream is smaller than that of the high resolution content stream.

Furthermore, the high resolution content stream and the low resolution content stream are synchronous in the time domain.

According to a further aspect of the invention, there is provided an apparatus for processing content stream in digital video broadcasting system comprising:

first encoder device for encoding the content stream to form a high resolution content stream, said high resolution content stream comprising at least one Group Of Pictures (GOP) structure;

second encoder device for encoding the content stream to form a low resolution content stream, said low resolution content stream comprising multiple GOP structures, a size of the GOP structure of the low resolution content stream being smaller than that of the high resolution content stream; and,

multiplexing device for communicating said high resolution content stream and said low resolution content stream for transmission over a communication channel as a digital content stream.

According to still another aspect of the invention, there is provided a computer program product, said computer program product comprising computer readable codes stored on the computer readable medium for implementing the methods according to the invention.

In addition to the above mentioned full screen usage scenarios, the low resolution video stream is implemented in the following application scenarios:

A. In an electronic program guide mode with small channel preview window. This solution fits into this kind of scenario well, allowing smoother transition and fast previewing of channel contents.

B. In a paid content service scenario in which contents are guarded by systems such as CA (Conditional Acceptance) and DRM (Digital Right Management).

The low resolution content stream can be delivered unencrypted to users to allow them to preview the content in a down-graded quality before they make the decision to pay for the high resolution contents.

Advantageously, the invention provides an improved tradeoff between cost/complexity of implementation and user experience enhancement with marginal increase of bandwidth utilization.

Moreover, the proposed method is based on currently adopted coding techniques, thus requiring only small changes in software to be implemented in the current digital video broadcasting infrastructure.

### BRIEF DESCRIPTION OF THE DRAWINGS

These and other features of the invention will be more readily understood from the following detailed description of the various aspects of the invention taken injunction with the accompanying drawings in which:

FIG. 1 depicts a GOP structure in accordance with the prior art;

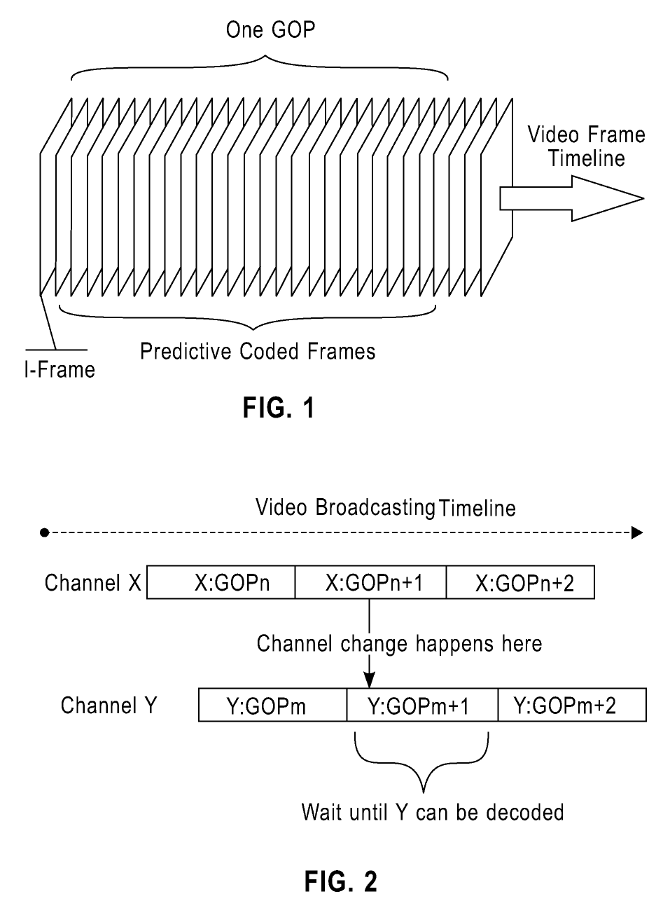

FIG. 2 is a diagram depicting the GOP video structure when changing channels according to the prior art;

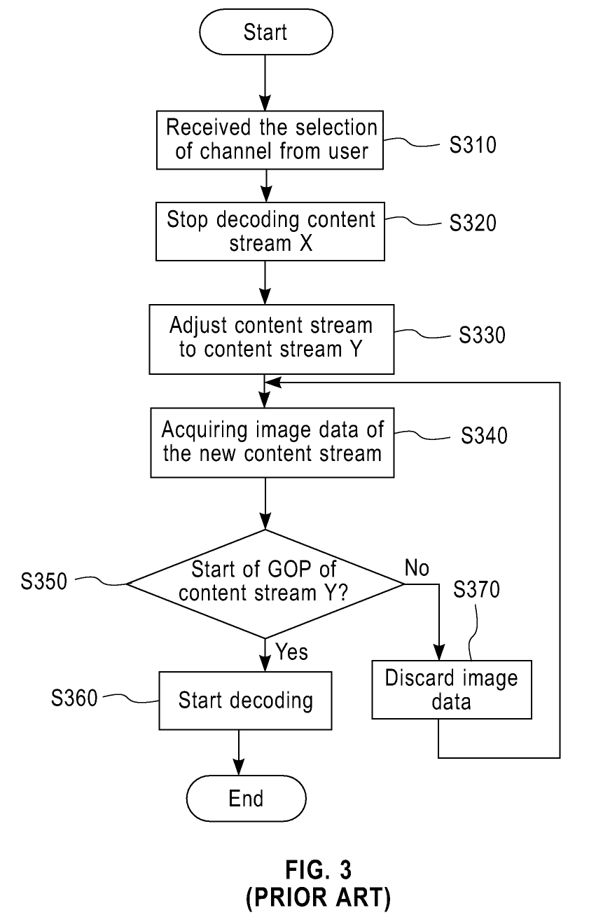

FIG. 3 is a flow diagram depicting the method of changing channel according to a prior art method;

FIG. 4 is a diagram of the displayed screen according to the GOP video structure when changing channel according to the present invention;

FIG. 5 is a flow diagram of the method according to the invention;

FIGS. 6A-6D are diagrams depicting various client screen displays with FIGS. 6C-6D depicting screen displays in accordance with the present invention;

FIG. 7 is a flow diagram depicting a channel change flow according to a further embodiment of the invention;

FIG. 8 is a flow diagram of the method for processing content stream in the end (broadcast) device according to the invention.

### DETAILED DESCRIPTION OF THE PREFERRED EMBODIMENTS

The method for processing content stream in digital video broadcasting system according to the invention will be described in detail with reference to the accompanying drawings herein below. It should be noted that the description here below is only for the purpose of illustration but not to limit the invention. A lot of technical details will be described in order that the skill in the art will be able to implement the invention according to the description, but this does not mean the invention must be implemented with these technical details; on the contrary, the invention can be implemented without some of the features or with some other additional features.

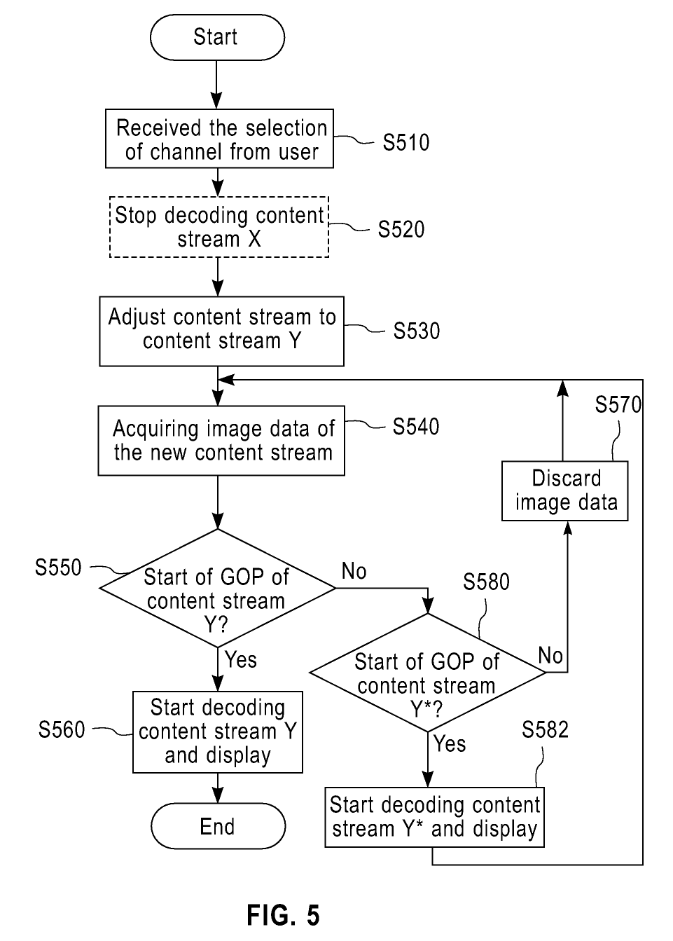

FIG. 4 is a flow chart depicting the method for enhancing user experience when changing channel according to the invention Compared with a normal content stream, the content stream of the invention introduces a specially encoded low resolution bit stream. By introducing this specially encoded low resolution content stream, the user experience during channel change will be enhanced remarkably.

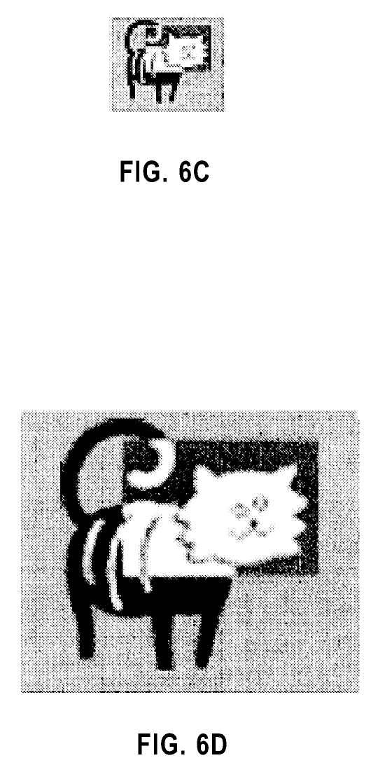

As shown in FIG. 4, there is depicted the broadcast flow of a digital broadcast stream including X and Y video channels that are selectable by a user via a user's receiver device, e.g., a digital receiver of multi-media, video, audio/visual content, etc. The content stream of a channel X is shown being broadcast in real time. An instruction 55 for changing channel from X to Y is received at the receiver device at a time when the play of content stream X proceeds to the (n+1)^{th} GOP. For the channel Y, because the start of the (m+1)^{th} GOP has gone away, the content of (m+1)^{th} GOP cannot be decoded at that point in time. The arrival of the start of the (m+2)^{th} GOP has to be waited in order to correctly decode the content stream Y. During the waiting period, the system will try to display the low resolution content stream Y*, wherein the size of GOP of the low resolution content stream Y* is much smaller than that of the high resolution content stream Y. Therefore, the waiting period for the start of GOP of content stream Y* is rather short. Then the decoder decodes the low resolution content stream Y* and displays it as shown in FIG. 6C. The display can be further zoomed to fit the size of the high resolution content stream Y as shown in FIG. 6D. In this way, when user changes channel, he/she will immediately see a low resolution image on the screen.

In order that the low resolution content stream Y* can be played immediately after channel change, a very short GOP structure is adopted. Although short GOP structure has the defects of low coding efficiency, the remarkably lowered video resolution will make up the drawbacks of lower coding efficiency. And, because the low resolution content is only for browsing, the requirement for coding quality is rather low, the compression rate can then be further increased. Therefore, the low resolution content stream Y* will use very small bandwidth compared with the high resolution content stream Y. The demand for channel bandwidth will not increase notably when combing the low resolution content stream Y* and the high resolution content stream Y in the transportation channel.

In the above-mentioned flow, the decoder will start decoding the content stream Y and display it as soon as the start of the GOP of the high resolution content stream has arrived. Preferably, in order to make content stream Y* smoothly switch to content stream Y, the low resolution content stream Y* and the high resolution content stream Y can be synchronized in the time domain; thus, the switch from Y* to Y is smooth.

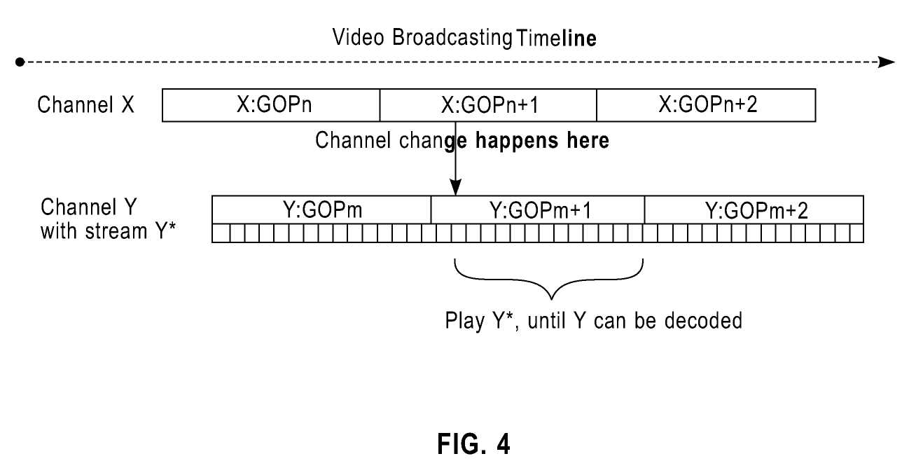

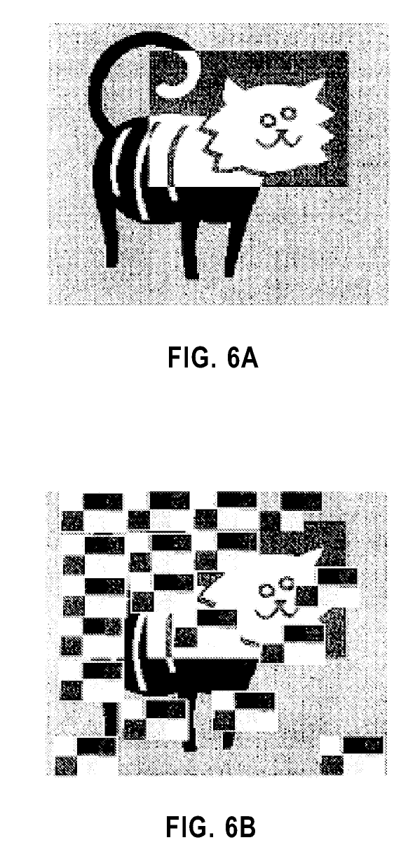

FIG. 5 shows a flow diagram of the channel changing method according to the invention in which step S510 to step S540 corresponds to step S310 and step S340 in FIG. 3 respectively, and will not be described again. The invention departs from the prior art limitations beginning at step S550, where it is deter mined whether new GOP has arrived. If a new GOP has arrived at the selected stream, the decoder will start decoding the image data of content stream Y and display the decoded high resolution content stream Y of the new channel at step S560, as shown in FIG. 6(a). If the result of the determination at step S550 shows that no new GOP of the content stream Y has arrived, it will be determined at step S580 whether new GOP of the content Y* has arrived. If yes, the decoder will start decoding the image data of content stream Y* at step S582 and display the decoded low resolution content stream Y* of the new channel, as shown in FIG. 6D, if the result of the determination at step S580 shows that no new GOP of content stream Y* has arrived, the image data will be discarded at step S570 and the flow returns to S540 to continue acquiring video image data.

The method for enhancing user experiences when changing channel according to the invention has been described in connection with FIG. 5 in the above.

Advantageously, the abovementioned method of the invention can be applied not only to the situation that users changes channel during their watching of television (TV) program, but also to the situation that user has just turned the TV on. The situation that a user turns on a TV is actually a process of selecting a channel. According to the invention, after receiving the select instruction for a channel from the user, a low resolution picture could be first displayed on the screen until the high resolution picture could be decoded. This in the same sense will increase enhancement of the user experience. In this case, step S520 in the flow diagram shown in FIG. 5 may be considered an optional step.

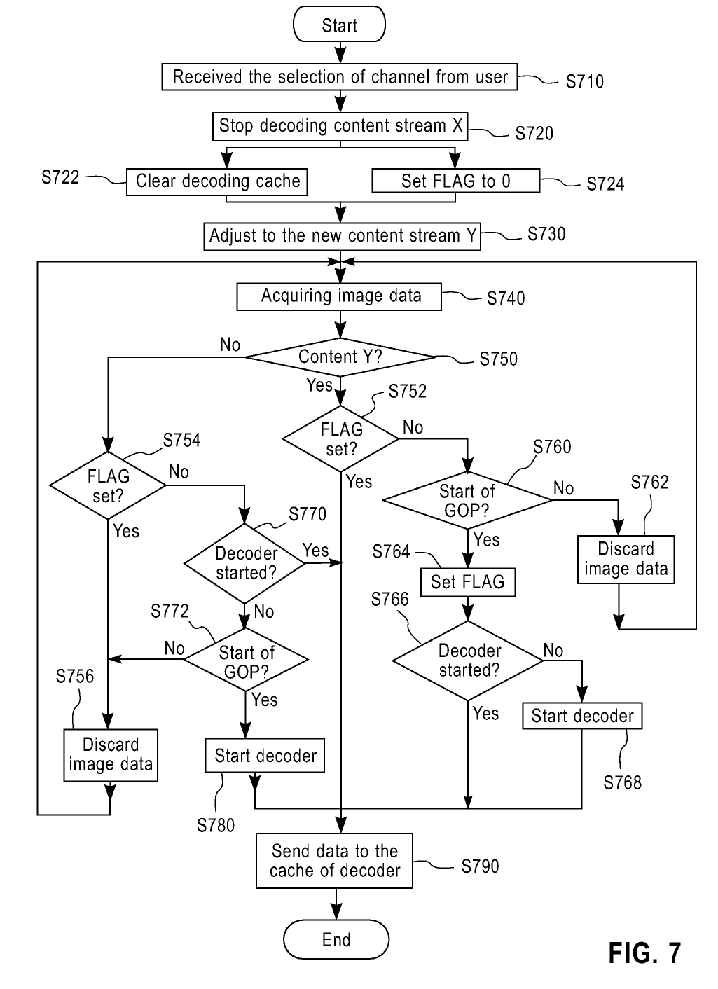

In order to give detailed description of the method of the invention, FIG. 7 shows a preferred embodiment to implement the above-mentioned “smooth” switch according to the invention. It should be noted that the preferred embodiment is only for the purpose of description but not to limit the scope of the invention.

In the flow diagram of FIG. 7, by setting a FLAG or lice data structure in a memory, the switch from Y* stream to Y stream is accomplished.

The channel change flow enter steps S720 in which the decoding of current content stream X in the decoder is stopped as the normal channel change operation flow and the cache in the decoder is cleared at step S722, after receiving a selection of new channel from user at step S710. At this time, normally a blank screen or a frozen frame of a previous channel is shown. And at step S724 a FLAG is cleared.

The flow then enter step S730 in which the content stream to be replayed is tuned to a new content stream Y by changing some system parameters.

The flow then enter step S740 in which the image data of new content stream Y are acquired. The image data comprise not only high resolution content stream Y but low resolution content stream Y* of the channel. These two content streams with different resolution are combined by time division multiplexing. It should be noted that the invention is not limited to some specific combined transportation manner; rather these two content streams with different resolution can be combined to transport in any manner.

At step S750, it is determined whether the image data acquired are high resolution content stream Y or low resolution content stream Y* (for example, Y and Y* can be assigned different PID or any other identifier allowed by program stream to differentiate one from another). If it is content stream Y, the flow enters step S752 to determine whether the FLAG has been set. If it is content stream Y*, the flow enters step S754 to determine whether the FLAG has been set to 1. If it is determined that the FLAG has been set to 1 at step S752, the flow enters step S790, in which the data will be sent to decoder for decoding. If it is determined that the FLAG has not been set to 1, the flow enters step S760, in which whether the start of GOP of content stream Y has arrived is determined. If not the data will be discarded at step S762 and the flow will return to step S740 to continue acquiring image data. If the start of GOP of content stream Y has arrived, the flow enters step S764 in which the FLAG is set to 1 and then the flow enters step S766 to determine whether the decoder has started to decode. If yes, the flow enters step S790, in which the data are sent to cache of the decoder for decoding. If it is determined that the decoder has not started decoding yet, the decoder is started at step S768 and at step S790, data are sent to the cache of the decoder to be decoded.

On the other hand, if it is determined at step S754 that the FLAG has been set to 1, which means that the decoding of content stream Y has started the image data of low resolution content stream Ye are discarded at step S756 and the flow returns to step S740 to continue acquiring image data. If it is determined that the FLAG has not been set to 1 at step S754, which means that the decoding of content stream Y has not started, whether the decoder has started decoding is determined at step S770. If yes, the flow enters step S790 where data are sent to the cache of the decoder to be decoded. If it is determined that the decoding has not started at step S770, the flow enters step S772, in which whether the start of GOP of content stream Y* has arrived is determined. If yes, the flow enters step S780 in which the decoder is started and data are sent to the cache of the decoder to be decoded at step S790. If it is determined that the start of GOP of stream Ye has not arrived, the flow enters step S756 in which the image data are discarded.

In the end, after step S790, the flow returns to step S740.

From the above-described flow, it can be seen that in the embodiment of the invention, whether to decode the high resolution content stream or the low resolution content stream is indicated by setting the FLAG. That is, only when the FLAG is cleared, the low resolution content stream in the image data is displayed. So long as the new GOP of high resolution content stream is received, the FLAG is set to 1 so that only the high resolution content stream in the image data is displayed while the low resolution content stream is discarded.

It should be noted that although the flow according to the invention are described step by step in connection with FIG. 7 in the above, those skilled in the art will understand that the steps performed are not limited to the sequence described above, and that other sequences between the steps are possible. For example, step S750 and step S752, step S766 and step S768, step S770 and step S772 can be interchanged with each other.

It should be understood that setting of the FLAG to implement the channel changing method according to the invention is one embodiment; the invention is not limited to it.

Further, it should be understood that the invention can also be used in the Electronic Program Guide (EPG), in which a small channel preview window displaying low resolution pictures is provided to make the preview of channel fast and smooth.

Further, it should be understood that the invention can also be used in the scenario that paid content are managed by CA and DRM system. In this case, high resolution content stream is encrypted and low resolution content stream is transmitted unencrypted to user to preview the content in a down-graded quality before they decide to pay for the high resolution content stream.

Compared with the alternative solutions in prior arts, the invention is a better tradeoff between cost/complexity of implementation and user experience enhancement with marginal increase of bandwidth utilization. The proposed method is based on currently adopted coding techniques, thus requires only small changes in software to be implemented in the current digital video broadcasting infrastructure.

In addition, further to the embodiment of FIG. 4, it is recommended that content stream y-l use the same video coding algorithm with content stream Y. Based on this assumption, the invention can be easily applied to the current digital video broadcasting infrastructure only with some small changes to the software. Control software of client decoder needs updating to support the switch from low resolution content stream to high resolution content stream when GOP of high resolution content stream arrives. The software in the end content generating devices needs updating so that low resolution content stream could be generated in a compatible bit stream syntax frame and combined with high resolution content stream to be transmitted by multiplexing.

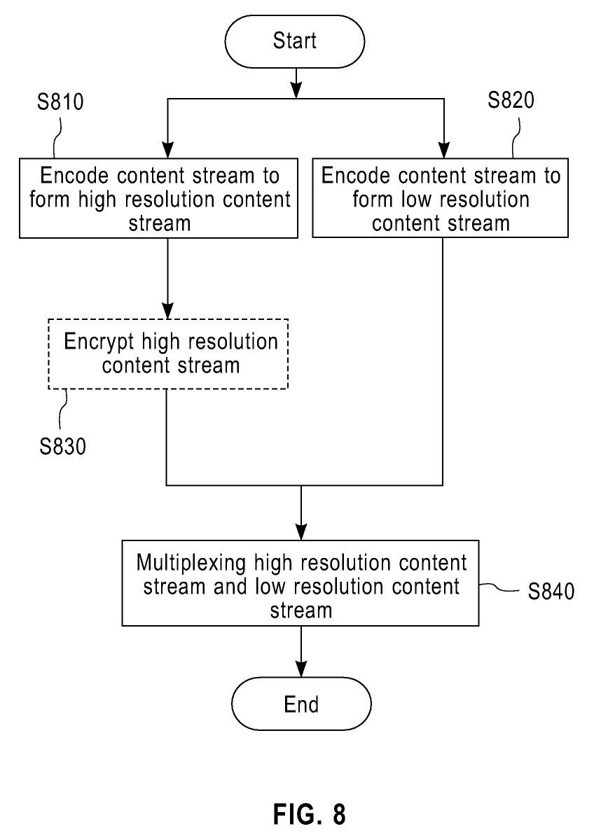

FIG. 8 is a flow diagram depicting the method for processing a content stream in the broadcast end device. At step S810, content stream of a channel is encoded to form high resolution content stream, wherein the high resolution content stream has rather big GOP structure. At step S820, the content stream of the channel is encoded to form low resolution content stream, wherein the size of GOP structure of the low resolution content stream is much smaller than that of the high resolution content stream. At step S840, multiplexing the high resolution content stream and the low resolution content stream formed in the above steps is multiplexed to form a multiplexed transmission stream.

In one optional embodiment, a further step S830 can be performed after step S810, which represents the step of encrypting the high resolution content stream.

For example, the high resolution content stream Y and the low resolution content stream Y* could be transmitted in the same transmission stream (TS) interleaved after multiplexing and differentiated one from another by adopting different PID.

In a further example, for the case of an IPTV system, the high resolution content stream Y and the low resolution content stream Y* could be transmitted in the same transmission stream (RTP) interleaved after multiplexing and differentiated one from another by extending/customizing field.

As would be apparent to skilled artisans, the system, method and computer program product for changing channels according to the invention can be embodied in the form of hardware, software or combination of thereof.

The invention can also be used in the Electronic Program Guide (EPG), in which a small channel preview window displaying low resolution pictures is provided to make the preview of a channel fast and seamless. In this case, the device according to the invention further comprises means for displaying multiple low resolution pictures on the screen.

Further, it should be understood that the invention can also be used in the scenario that paid content are managed by CA and Digital Rights Management (DRM) system. In this case, high resolution content stream is encrypted and the device according to the invention further comprises means for decrypting the high resolution content stream.

In addition, the invention can also be implemented by way of: providing storage medium with executable codes stored thereon which implement the method described above directly or indirectly to the system or device, and the computer of CPU of the system or device reading out the executable codes and executing the codes.

In this case, as long as the system or the device has the ability to execute program, the way of implementation will not be limited to program. And the program can be in any form, e.g., target program, program executed by parser or script program provided to the OS.

The computer readable medium abovementioned comprises but not limit to: memory and storage unit, semiconductor devices, discs such as optical disc, magnetic discs or MO discs and any other medium adapted to store information.

In addition, the invention can also be implemented by a client computer downloading the computer program codes from a certain website from the Internet, installing them to the computer and executing them.

Further to the embodiments described hereinabove, a user device, such as an IPTV receiver, broadcast television receiver or satellite broadcast receiver, or a computer device (PCs and mobiles, etc.) processes content stream in digital video broadcasting system. In response to the reception of a selection of channel by the user, the user receiver device receives data comprising high resolution content stream and low resolution content stream corresponding to the selected channel, wherein the respective high resolution content stream and low resolution content stream is comprised of at least one GOP structure. The receiver further detects the start of the high resolution content stream. A decoder device for decodes and displays the high resolution content stream in response to the detection of the start of the high resolution content stream; otherwise, will decode and display the low resolution content stream for decoding and displaying.

Preferably, the size of the GOP structure of the low resolution content stream is smaller than that of the high resolution content stream. The decoding and displaying device stops the decoding of content stream associated with the last channel in response to the selection of channel by the user. Preferably the high resolution content stream and the low resolution content stream are synchronous in the time domain. The decoding and displaying device further comprises a device for zooming the low resolution content stream to the same size of the high resolution content stream.

At the broadcast side, whether broadcasting IPTV, broadcast television or satellite broadcast, or digital video content for streaming to a computer device (PCs and mobiles, etc.), a device is provided to prepare the content stream for broadcast transmission. An encoder device encodes the content stream to form high resolution content stream, the high resolution content stream including at least one GOP structure. The encoder device flirter encoding the content stream to form a low resolution content stream, the low resolution content stream comprising multiple GOP structures. The size of the GOP of the low resolution content stream is smaller than that of the high resolution content stream. A multiplexer device is further provided for multiplexing the high resolution content stream and the low resolution content stream for transmission over a communication channel as a digital content stream associated with a channel.

If desired, the high resolution content can be further encrypted the device further comprising an encryption device for encrypting high resolution content.

Although the embodiments of the invention are described in detail above in connection with the drawings, it should be understood that all the embodiments described are only for the purpose of illustrating the invention, thus will not limit the invention. For those skilled in the art, variations and modifications can be made without departing from the spirit and scope of the invention, which is defined by the appended claims and their equivalents.

What we claim:

1. A method for processing content stream in digital video broadcasting system, comprising the steps of:
receiving, in response to a user selection of a broadcast channel, a content stream comprising a high resolution content stream and a low resolution content stream corresponding to the selected channel, wherein the respective high resolution content stream and low resolution content stream is comprised of at least one Group Of Pictures (GOP) structure;
detecting the start of the high resolution content stream; and, in response to detection,
decoding and displaying the high resolution content stream in response to the detection of the start of the high resolution content stream; otherwise, decoding and displaying the low resolution content stream.

2. The method according to claim 1, wherein the size of the GOP structure of the low resolution content stream is smaller than the size of the GOP structure of the high resolution content stream.

3. The method according to claim 1, further comprising the steps of:
in response to the receiving channel selection, stopping the decoding of a content stream associated with a last selected channel.

4. The method according to claim 1, wherein the high resolution content stream and the low resolution content stream are synchronous in the time domain.

5. The method according to claim 1, wherein said decoding and displaying the low resolution content stream further comprises: zooming the low resolution content stream to an identical size of the high resolution content stream.

6. The method according to claim 1, wherein the high resolution content stream is encrypted and the method further comprises: decrypting said high resolution content stream before detecting the start of the high resolution content stream.

7. The method according to claim 1, further comprising: displaying multiple low resolution pictures on the screen at the same time.

8. A method for processing content stream in digital video broadcasting system, comprising the steps of
encoding the content stream to form high resolution content stream, said high resolution content stream comprising at least one Group Of Pictures (GOP) structure;
encoding the content stream to form low resolution content stream, said low resolution content stream comprising multiple GOP structures, wherein the size of the GOP of the low resolution content stream is smaller than that of the high resolution content stream; and,
multiplexing said high resolution content stream and said low resolution content stream for transmission over a communication channel as a digital video stream associated with a channel.

9. The method according to claim 8, further comprising the step of encrypting said high resolution content stream.

10. An apparatus for processing digital video signals comprising.
means for receiving, in response to a user selection of a broadcast channel, a content stream comprising high resolution content stream and low resolution content stream corresponding to the selected channel, wherein the high resolution content stream and low resolution content stream is respectively comprised of at least one Group Of Pictures (GOP) structure;
means for detecting the start of the high resolution content stream; and
means for decoding and displaying the high resolution content stream in response to the detection of the start of the high resolution content stream; otherwise, decoding and displaying the low resolution content stream.

11. The apparatus according to claim 10, wherein a size of the GOP structure of the low resolution content stream is smaller than a size of the GOP structure of the high resolution content stream.

12. The apparatus according to claim 10, wherein in response to receiving a channel selection from the user, the decoding and displaying means stopping the decoding of content stream associated with a last selected.

13. The apparatus according to claim 10, wherein the high resolution content stream and the low resolution content stream are synchronous in the time domain.

14. The apparatus according to claim 10, wherein the decoding and displaying means further comprises means for zooming the low resolution content stream to to an identical size of the high resolution content stream.

15. The apparatus according to claim 10, wherein the high resolution content stream is encrypted, said apparatus further comprising: means for decrypting said high resolution content stream.

16. The apparatus according to claim 10, further comprising: means for displaying multiple low resolution pictures on the screen at the same time.

17. An apparatus for processing content stream in digital video broadcasting system comprising:
first encoder device for encoding the content stream to form a high resolution content stream, said high resolution content stream comprising at least one Group Of Pictures (GOP) structure;
second encoder device for encoding the content stream to form a low resolution content stream, said low resolution content stream comprising multiple GOP structures, a size of the GOP structure of the low resolution content stream being smaller than that of the high resolution content stream; and,
multiplexing device for communicating said high resolution content stream and said low resolution content stream for transmission over a communication channel as a digital content stream.

18. The apparatus according to claim 17, further comprising means for encrypting the high resolution content stream.

19. A computer program product said computer program product comprising computer readable medium with computer readable code stored thereon which, when executed by the computer, will implement the method steps comprising:
receiving, in response to a user selection of a broadcast channel, a content stream comprising a high resolution content stream and a low resolution content stream corresponding to the selected channel, wherein the respective high resolution content stream and low resolution content stream is comprised of at least one Group Of Pictures (GOP) structure;
detecting the start of the high resolution content stream; and, in response to detection,
decoding and displaying the high resolution content stream in response to the detection of the start of the high resolution content stream; otherwise, decoding and displaying the low resolution content stream.
